(19) United States
(12) Patent Application Publication
(10) Pub. No.: US 2018/0179642 A1
(43) Pub. Date: Jun. 28, 2018

(54) Component, in Particular Structural Component, for a Motor Vehicle, as well as a Method for Producing a Component

(71) Applicant: Daimler AG, Stuttgart (DE)

(72) Inventors: Damien CLOSE, Tuebingen (DE); Peter FEUSER, Unterensingen (DE); Rigis LALLEMENT, Boeblingen (DE); Robert MAYRHOFER, Boeblingen (DE); Marion MERKLEIN, Nuernberg (DE); Claas Felix RASCHKE, Holzgerlingen (DE); Nicolas STEIN, Metz (FR); Albert TIDU, Metz (FR)

(73) Assignee: Daimier AG, Stuttgart (DE)

(21) Appl. No.: 15/128,644

(22) PCT Filed: Feb. 17, 2015
(86) PCT No.: PCT/EP2015/000347

§ 371 Date: Sep. 23, 2016

(30) Foreign Application Priority Data
Mar. 29, 2014 (DE) 10 2014 004 657.5

(51) Int. Cl. C23C 28/02; B32B 15/01

(52) U.S. Cl. CPC C23C 28/021; B32B 15/013

(57) ABSTRACT

A component, in particular a structural component for a motor vehicle, is disclosed. The component has a basic body formed from a hot-formable steel, which is provided with a coating at least in one partial region. The coating has a first layer of aluminum-silicon and at least one second layer, where the first layer is arranged between the basic body and the second layer. The second layer is formed from zinc-cobalt or zinc-manganese or from manganese. A method for producing a component, in particular a structural component for a motor vehicle, is also disclosed.

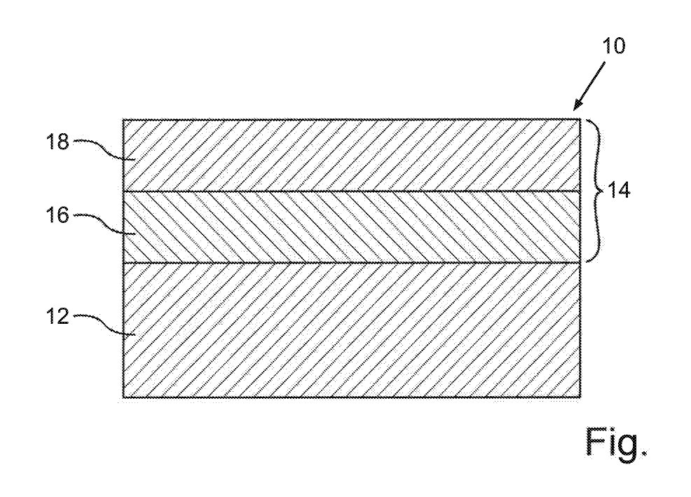

The invention relates to a component, in particular a structural component, for a motor vehicle, according to the preamble of claim 1 as well as a method for producing a component according to the preamble of claim 5.

Such a component and such a method can be gleaned as known from DE 10 2009 007 909 A1. The component comprises a basic body formed from a hot-formable steel which is provided with a coating at least in one partial region, said coating comprising a first layer comprising an aluminium-silicon alloy and a second layer, wherein the first layer is arranged between the basic body and the second layer.

In the course of the production of the component, the basic body is hot formed together with the coating. This means that the basic body is provided with the coating temporally before the hot forming. In the course of the production of the coating, the first layer is arranged between the basic body and the second layer.

The basic body is, for example, a hot-formable metal sheet, wherein the basic body is formed, for example, from boron steel. In the scope of hot forming, the basic body is exposed to high temperatures together with the coating. Usually, a coating having at least two layers is also referred to as a “coating system”.

Here, two coating systems for hot-formable steel sheets are known from general prior art: a first of these coating systems is hot-dip galvanising, wherein the second coating system is hot-dip aluminising. This means that the steel of the basic body is either hot-dip galvanised or hot-dip aluminised. Such hot-dip galvanised or hot-dip aluminised steels are used, for example, in the series production of press-hardened structural components, in particular for motor vehicles.

Hot-dip galvanised steels offer good corrosion resistance due to the reduced electrochemical voltage in comparison to the steel substrate (cathodic corrosion protection). The following phenomena are hereby problematic in this type of coating: liquid metal embrittlement results during hot forming at high temperatures, Liquid zinc diffuses into grain boundaries of the steel substrate and leads to the formation of tears in the substrate in the case of single-step press hardening due to mechanical and thermal tensions. This phenomenon can be prevented by two-step forming. Here, conventional forming occurs at room temperature. Then, press hardening occurs with a low degree of forming. Here, vaporisation of the zinc layer occurs, which means a loss of corrosion protection material. Furthermore, oxidation of the zinc layer occurs. As a consequence, these components are cleaned or irradiated after the forming process in order to enable, for example, painting work. The diffusion phenomena of iron into the coating, due to the process temperatures during the hot forming, cause an increase of the iron proportion on the surface and a reduction of cathodic protection. Red rust thereby appears on the component surface.

Hot-dip aluminised steels have good forming properties in single-step press hardening without liquid metal embrittlement and without tear formation in the steel substrate. Such a coating leads to stable corrosion products and a cleaning of the hot formed product is not required. However, with this type of coating, the following phenomenon is problematic: hot-dip aluminising offers no galvanic protection effect. In other words, the component cannot be protected from corrosion by the principle of the sacrificial anode. The diffusion phenomena of iron into the coating, due to the process temperatures during hot forming, cause an increase of the iron proportion on the surface. Red rust thereby appears on the component surface.

The object of the invention is to create a component and a method of the type referred to at the beginning in which the problems referred to can be prevented.

This object is solved according to the invention by a component having the features of claim 1 and by a method having the features of claim 5. Advantageous embodiments with expedient and non-trivial developments of the invention are specified in the remaining claims.

In order to create a component having a coating system in which the problems referred to at the beginning can be prevented, it is provided according to the invention that the second layer is formed from zinc-cobalt (ZnCo) or zinc-manganese (ZnMn) or from manganese (Mn),

Using the coating with zinc-cobalt or zinc-manganese or manganese as a second layer, an intermetallic AlSiFe barrier layer can be created, by means of which the liquid metal embrittlement can be at least reduced. Additionally, the diffusion of iron into the coating can be reduced by the aluminium-silicon coating in the form of the first layer, such that the occurrence of red rust can be prevented or at least kept low. Furthermore, a good adhesion of the coating can be ensured by the interdiffusion layers. In comparison to a pure zinc layer, i.e. in comparison to a layer which is formed from substantially pure zinc (Zn), a particularly advantageous cathodic corrosion protection can be achieved by the zinc-alloyed layer in the form of the second layer (here, a pure zinc layer is understood to be such a layer which has at least 99 percent by weight (% by weight) zinc (Zn) and the remainder, for example, impurities).

Additionally, with the component according to the invention, stable corrosion products having a reduced dissolution rate can be achieved by using the aluminium-silicon layer. Furthermore, stable corrosion products having a reduced dissolution rate can be achieved by alloying zinc. Additionally, the zinc vaporisation can be at least reduced by the increased melting point when alloying zinc.

Alternatively, the second layer can consist of manganese. In this way, cathodic corrosion protection is also achieved, since manganese has a relatively low electrochemical potential compared to iron. Furthermore, in the case of a heat treatment of the component, in the course of the press hardening, an interdiffusion takes place between the first and the second layer which leads to galvanic coupling of the cathodic system formed from these two layers, whereby a strong adhesion of the second layer to the first layer is achieved. A component having this coating system can therefore also be press hardened in one step.

If the second layer consists of manganese, then the second layer advantageously has a thickness lower than 5 μm. This relatively low layer thickness has the advantage that, on the one hand, said corrosion protection is just as good as with thicker layers, wherein the component coated in this way can therefore be joined particularly simply by means of thermal joining methods, contrary to work pieces having thicker coatings. Due to the relatively low thickness of the second layer, in particular the thermal weldability of the component coated in this way can be considerably improved. Such a thin second layer is advantageously applied by means of a physical or chemical vapour deposition, because the manganese can be applied simply and above all in a particularly thin layer with the aid of this method. Alternatively, the second layer formed from manganese can also be applied by means of an electrolytic method.

A further advantageous embodiment of the invention provides that the weight proportion of silicon in the aluminium-silicon alloy of the first layer is up to 12 percent.

The invention also includes a method for producing a component, wherein the second layer made from zinc cobalt or zinc manganese is formed temporally before the hot forming of the basic body.

In the case of the method according to the invention for producing a component, in particular a structural component for a motor vehicle, a coating, which comprises a first layer comprising an aluminium-silicon alloy and a second layer, is applied at least in one partial region of a basic body formed from a hot-formable steel and then hot formed together with the coating, wherein the first layer is arranged between the basic body and the second layer. Here, it is provided according to the invention that zinc-cobalt (ZnCo) or zinc-manganese (ZnMn) or manganese (Mn) is applied as the second layer.

Further advantages, features and details of the invention result from the description below of a preferred exemplary embodiment as well as by means of the drawing. The features and feature combinations referred to above in the description as well as the features and feature combinations referred to in the description of the figures and/or shown in the single figure alone are not only applicable in the respectively specified combination, but also in other combinations or alone, without leaving the scope of the invention.

Exemplary embodiments of the invention are explained in more detail by means of the single FIGURE, in which a component is shown in a schematic side view which has a basic body which is provided with a two-layer coating.

The FIGURE shows, in a schematic sectional view, a component referred to as a whole as 10. The component 10 is, for example, a structural component of a motor vehicle, in particular of a passenger motor vehicle. The component 10 can here be formed as a body component of the motor vehicle. In body construction, for the majority of car manufacturers, press hardened steels have been established in order to be able to achieve weight reductions in comparison to conventional steels. A variety of requirements are set for the components, in particular with regard to corrosion protection, paint adhesion, wettability, phosphating, hot formability and with regard to weight reduction. In particular with press hardening, tear formations on such components should be prevented.

The component 10 has a basic body 12 which is formed from a hot-formable steel. The basic body 12 is provided with a coating 14 at least in one partial region. Therefore, the basic body 12 is a steel substrate which is formed from a hardenable steel or a deep-drawing steel. In particular, boron steels or manganese boron steels and microalloyed steels are suitable for this.

In the scope of production of the component 10, the basic body 12 is hot formed together with the coating 14, in particular press hardened. This means that the basic body 12 is provided with the coating 14 temporally before the hot forming, such that the basic body 12 is hot formed together with the coating 14 temporally after the application of the coating 14 on the basic body 12.

From the FIGURE it is recognisable that—in the course of the production of the coating 14—a first layer 16 and an additional, second layer 18 of the coating 14 are produced. This means that the coating 14 has a first layer 16 and a second layer 18, wherein the first layer 16 is arranged between the basic body 12 and the second layer 18. Presently, the first layer 16 is applied directly to the basic body 12. This means that the first layer 16 touches the basic body 12. The second layer 18 is applied directly to the first layer 16.

The production of the coating 14 or the layers 16 and 18 occurs for example by a PVD method (PVD—Physical Vapour Disposition), a CVD method (CVD—Chemical Vapour Disposition), a dipping method, a slurry method, galvanic or electrolytic methods or thermal spraying.

The first layer 16 is formed from aluminium-silicon (AlSi). The second layer 18, however, is formed from manganese (Mn), zinc-manganese (ZnMn) or from zinc-cobalt (ZnCo). The liquid metal embrittlement and the formation of red rust can be prevented or at least kept low by means of the coating 14. Additionally, cathodic corrosion protection can be achieved. Furthermore, good adhesion of the coating 14 as well as stable corrosion products are able to be presented. Additionally, the zinc vaporisation can be at least reduced.

If the second layer consists of manganese, then this second layer 18 preferably has a low thickness, advantageously lower than 5 μm.

The weight proportion of silicon in the aluminium-silicon alloy of the first layer 16 is 12 percent. The use of this first aluminised layer acts positively on the component 10 during press hardening,

By means of the coating 14, advantageous mechanical properties of the component 10 can therefore be achieved. On the other hand, particularly effective corrosion protection can be presented.

1.-6. (canceled)

7. A component, comprising:
a basic body formed from a hot-formable steel;
a coating disposed on at least one partial region of the basic body, wherein the coating has a first layer comprising aluminum-silicon and a second layer, and wherein the first layer is disposed between the basic body and the second layer;
wherein the second layer is formed from zinc-cobalt or zinc-manganese or manganese.

8. The component according to claim 7, wherein the second layer has a thickness lower than 5 μm if the second layer is formed from manganese.

9. The component according to claim 7, wherein a weight proportion of silicon in the aluminum-silicon of the first layer is 12 percent.

10. The component according to claim 7, wherein the hot-formable steel is a boron steel.

11. The component according to claim 7, wherein the component is a structural component of a motor vehicle.

12. A method for producing a component, comprising the steps of:
providing a basic body formed from a hot-formable steel;
providing the basic body with a coating in at least one partial region of the basic body, wherein the coating has a first layer comprising aluminum-silicon and a second layer;
hot-forming the basic body together with the coating, wherein the first layer is disposed between the basic body and the second layer;
wherein the second layer is formed from zinc-cobalt or zinc-manganese or manganese;
and wherein the second layer is formed temporally before the step of hot-forming.

13. The method according to claim 12, wherein the second layer is applied to the first layer by physical or chemical vapor deposition or an electrolytic deposition.
